(19) United States
(12) Patent Application Publication
(10) Pub. No.: US 2017/0200149 A1
(43) Pub. Date: Jul. 13, 2017

(54) AUTHENTICATING PAYMENT CREDENTIALS IN CLOSED LOOP TRANSACTION PROCESSING

(71) Applicant: MasterCard International Incorporated, Purchase, NY (US)

(72) Inventors: Alexander Antunovic, Chappaqua, NY (US); Charl Frederik Botes, White Plains, NY (US)

(21) Appl. No.: 15/009,612

(22) Filed: Jan. 28, 2016

Related U.S. Application Data
(60) Provisional application No. 62/276,651, filed on Jan. 8, 2016.

(51) Int. Cl. G06Q 20/34; G06Q 20/20; G06Q 20/22; G06Q 20/10; G06Q 20/38; G06Q 20/40

(52) U.S. Cl. CPC G06Q 20/352; G06Q 20/3821; G06Q 20/40975; G06Q 20/341; G06Q 20/227; G06Q 20/105; G06Q 20/204

(57) ABSTRACT

Presentation of an open-loop smart chip-based payment device is obtained at a terminal-reader assembly in a closed-loop transit environment. Verification of cryptographic credentials associated with the open-loop smart chip-based payment device is carried out at a transit payment network interface processor within the closed-loop transit environment. A financial check of an account associated with the open-loop smart chip-based payment device is performed. Responsive to determining that the verification and financial check are successful, access to the transit environment is granted to a holder of the open-loop smart chip-based payment device.

### CROSS-REFERENCE TO RELATED APPLICATIONS

This patent application claims the benefit of U.S. Provisional Patent Application Ser. No. 62/276,651, filed Jan. 8, 2016, entitled AUTHENTICATING PAYMENT CREDENTIALS IN CLOSED LOOP TRANSACTION PROCESSING. The complete disclosure of the aforementioned U.S. Provisional Patent Application Ser. No. 62/276,651 is expressly incorporated herein by reference in its entirety for all purposes.

### FIELD OF THE INVENTION

The present invention relates generally to the electronic and computer arts, and, more particularly, to cryptographic authentication of credentials.

### BACKGROUND OF THE INVENTION

The use of payment cards, such as credit cards, debit cards, and pre-paid cards, has become ubiquitous. Most payment card accounts have one or more associated physical cards; however, the use of non-traditional payment devices, such as appropriately-configured “smart” cellular telephones, is increasing.

Robust authentication techniques are available when payment cards are used within the traditional payment card infrastructure. These techniques are currently not available if payment cards are used outside that infrastructure; e.g., in a proprietary or closed loop environment.

### SUMMARY OF THE INVENTION

Principles of the present invention provide techniques for authenticating payment credentials in closed loop transaction processing. In one aspect, an exemplary method includes obtaining, at a terminal-reader assembly in a closed-loop transit environment, presentation of an open-loop smart chip-based payment device; carrying out verification of cryptographic credentials associated with the open-loop smart chip-based payment device, at a transit payment network interface processor within the closed-loop transit environment; performing a financial check of an account associated with the open-loop smart chip-based payment device; and, responsive to determining that the verification and financial check are successful, granting access to the transit environment to a holder of the open-loop smart chip-based payment device.

Aspects of the invention contemplate the method(s) described herein performed by one or more entities herein, as well as facilitating of one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps (e.g., transit payment network interface processor, networked with a transit host). Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the invention can provide substantial beneficial technical effects, such as enhanced security and fraud prevention. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement at least a portion of some techniques of the invention;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, useful in connection with one or more embodiments of the invention;

FIGS. 3 and 4 provide an exemplary detailed view of operation of an exemplary payment card network, in accordance with an aspect of the invention;

FIG. 5 shows a group of payment network interface processors, such as may be used with the network of FIGS. 3 and 4;

FIG. 6 shows a port arrangement on a payment network interface processor, such as may be used with the network of FIGS. 3 and 4;

FIG. 7 shows an illustrative case wherein an issuer has multiple payment network interface processors;

FIG. 8 is a block diagram of an exemplary computer system useful in one or more embodiments of the invention;

FIG. 9 shows a closed-loop transit system using proprietary fare cards, as known from the prior art;

FIG. 10 shows a standard EMV transaction flow, as known from the prior art;

FIG. 11 shows a MASTERCARD CONTACTLESS MAGSTRIPE PROFILE transaction, as known from the prior art (the skilled artisan will appreciate that MASTERCARD CONTACTLESS was formerly known as MASTERCARD PAYPASS);

FIG. 12 shows a pay-as-you go contactless transaction architecture, in accordance with an aspect of the invention; and

FIG. 13 shows a pre-funded contactless transaction architecture, in accordance with an aspect of the invention.

### DETAILED DESCRIPTION OF PREFERRED EMBODIMENTS

### Payment Devices and Associated Payment Processing Networks

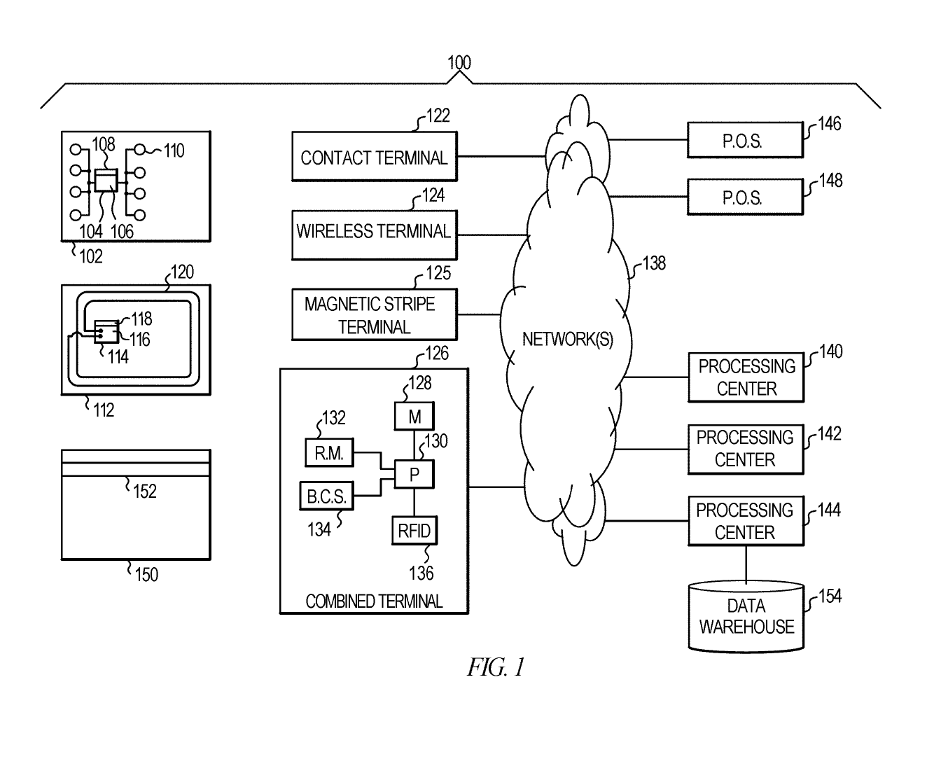

With regard to payment card and similar payments, attention should now be given to FIG. 1, which depicts an exemplary embodiment of a system 100, according to an aspect of the invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 typically functions with other types of devices in lieu of or in addition to “smart” or “chip” cards 102, 112; for example, a conventional magnetic stripe device 150, such as a card having a magnetic stripe 152. Furthermore, an appropriately configured mobile device (e.g., “smart” cellular telephone handset, tablet, personal digital assistant (PDA), and the like) can be used to carry out contactless payments in some instances; for example, via near field communications (NFC), wherein the appropriately configured mobile device acts like a contactless card 112 (or, with an electronic wallet present, like multiple such cards).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present invention is the MUILTOS® operating system licensed by MAOSCO Limited. (MAOSCO Limited, St. Andrews House, The Links, Kelvin Close, Birchwood, Warrington, WA3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif. 94404, USA). It will be appreciated that applications can be configured in a variety of different ways.

The skilled artisan will also be familiar with the MasterCard® Contactless specifications, available under license from MasterCard International Incorporated of Purchase, N.Y., USA (marks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

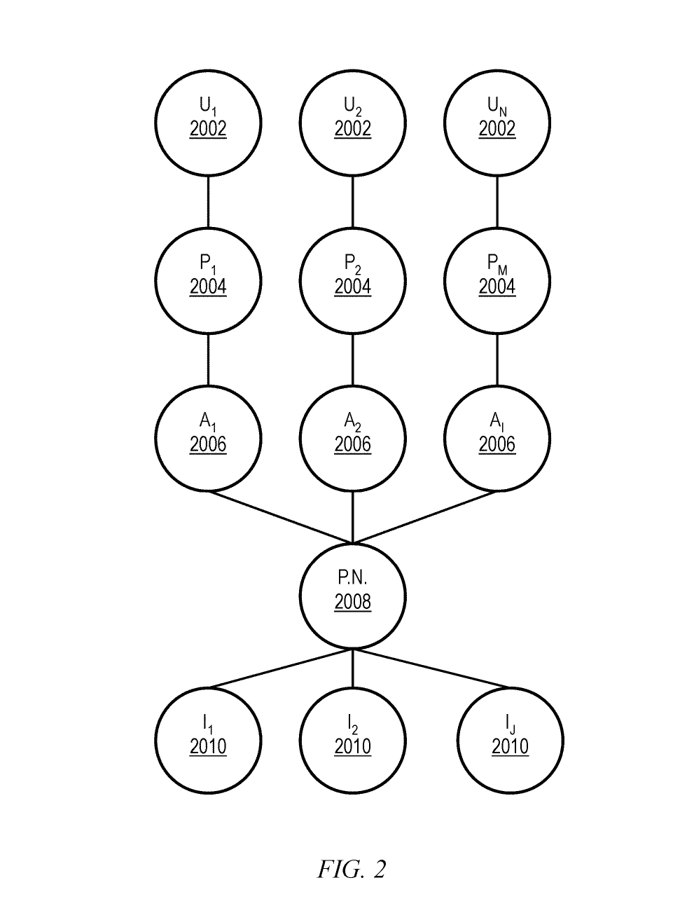

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone, tablet, or the like.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 150. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be International Organization for Standardization (ISO) 7816-compliant contact cards or devices or NFC (Near Field Communications) or ISO 14443-compliant proximity cards or devices. In operation, card 112 can be touched or tapped on the terminal 124 or 128 (or an associated reader), which then contactlessly transmits the electronic data to the proximity IC chip in the card 112 or other wireless device.

One or more of the processing centers 140, 142, 144 can include a database such as a data warehouse 154.

The system depicted in FIG. 1 may in general involve not only conventional transactions at “brick and mortar” merchants, but also card-not-present transactions, such as card-not-present Internet transactions or card-not-present recurring payments. In some instances, an Internet Protocol (IP) address may be captured during card-not-present Internet transactions. In exemplary card-not-present Internet transactions, an individual utilizes his or her home computer to communicate with a server of an e-commerce merchant over the Internet. The individual provides his or her PAN to the merchant's server. The merchant utilizes the PAN to initiate an authorization request, and upon receiving an authorization request response indicating approval, will complete the e-commerce transaction. In exemplary card-not-present recurring payments, an individual provides his or her PAN and related data to a merchant (e.g., via phone or postal mail). The merchant utilizes the PAN to initiate an authorization request, and upon receiving an authorization request response indicating approval, will complete the recurring transaction.

In some cases, there can be payment card accounts which do not have physical cards or other physical payment devices associated therewith; for example, a customer can be provided with a PAN, expiration date, and security code but no physical payment device, and use same, for example, for card-not-present telephone or internet transactions. In this regard, a “cardholder” should be understood to refer to the account holder of a payment card account, regardless of whether the holder actually has a physical payment card or other physical payment device.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, 1₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal. Note, also, that elements 2006, 2010 represent the entities that actually carry out processing for the acquirers and issuers respectively; in some instances, these entities carry out their own processing; in other entities, they utilize acquirer processors and issuer processors, respectively.

During a conventional credit authorization process, the cardholder 2002 pays for the purchase and the merchant 2004 submits the transaction to the acquirer (acquiring bank) 2006. The acquirer verifies the card number, the transaction type, and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

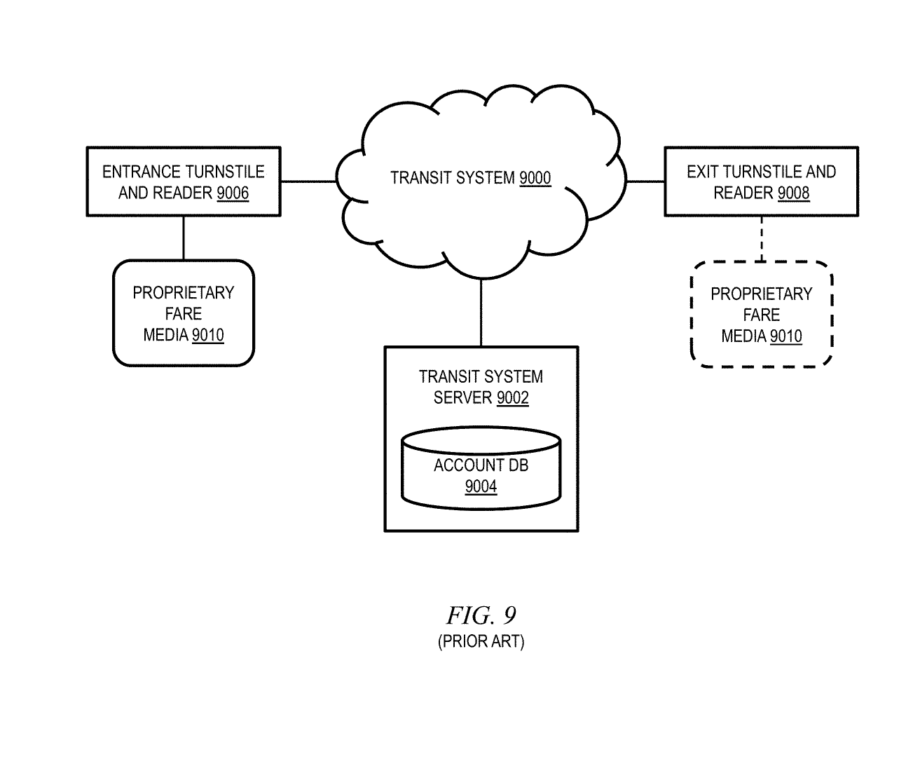

It will be appreciated that the network 2008 shown in FIG. 2 is an example of a payment network configured to facilitate transactions between multiple issuers and multiple acquirers, which may be thought of as an “open” system. Some embodiments of the invention may be employed in relation to payment card accounts using other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. The skilled artisan will also be familiar with three-party models, wherein the acquirer and issuer are the same entity. Note that a three-party model (proprietary or closed payments network) where authorization nevertheless involves a communication with an issuer is to be distinguished from a closed-loop transit environment or the like with a transit PNIP 1212 discussed below standing in for an issuer during credential authentication as well as from a prior-art closed loop environment such as is depicted in FIG. 9.

Messages within a network such as network 138 and/or network 2008, may, in at least some instances, conform to the International Organization for Standardization (ISO) Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583: 1993 (1993)
ISO 8583: 1987 (1987)

As used herein, a “payment card network” is a communications network that uses payment card account numbers, such as primary account numbers (PANs), to authorize, and to facilitate clearing and settlement of payment card transactions such as for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing or procurement card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN)(which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. No. 6,636,833 (expressly incorporated herein by reference in its entirety for all purposes) and U.S. Pat. No. 7,136,835 (expressly incorporated herein by reference in its entirety for all purposes) of Flitcroft et al.

Some payment card networks connect multiple issuers with multiple acquirers; others use a three party model. Some payment card networks use ISO 8583 messaging.

Non-limiting examples of payment card networks that connect multiple issuers with multiple acquirers are the BANKNET® network and the VISANET® network. Other non-limiting examples of payment card networks include the AMERICAN EXPRESS® and DISCOVER® networks.

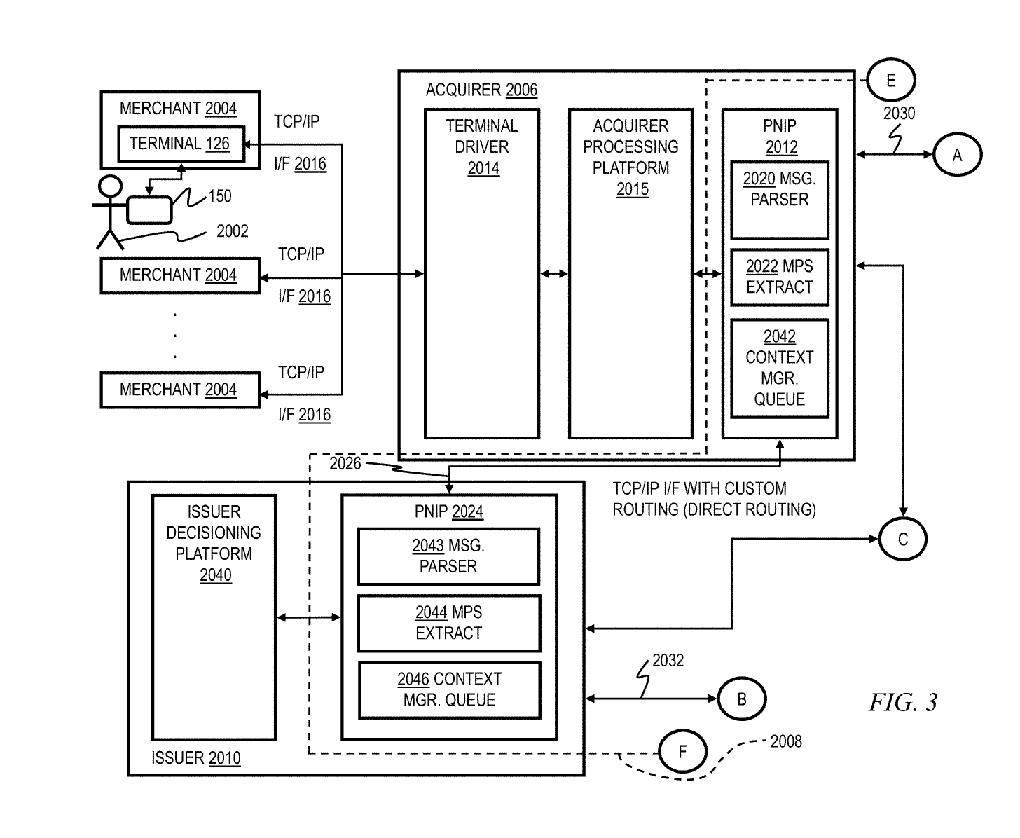

Still referring to FIG. 2, and with reference also now to FIGS. 3 and 4, by way of review and provision of additional detail, a consumer 2002 effectively presents his or her card 150 or other payment device (e.g., presents suitably configured “smart” phone or uses an e-wallet) to the terminal 126 of a merchant 2004. A mag stripe card 150 and combined terminal 126 are shown by way of example, but are intended to generally represent any kind of payment device and any kind of terminal. The effective presentation can happen directly (user enters a brick and mortar location of a merchant 2004) or virtually (user logs on to a web site of a merchant 2004 via a browser of a personal computer or the like, or calls on the telephone, and provides card information, or sends a “snail” mail with payment card account information to a merchant). The merchant terminal 126 captures the card account information (by swiping or wireless communication if directly presented; by manual keying or reading data if remote) and forwards same to the acquirer 2006. Interaction between the merchant and cardholder is outside the purview of the payment card network per se. The payment card network becomes involved at the connection between the acquirer 2006 and network 2008; the dotted line between points E and F in FIGS. 3 and 4 encompasses the network 2008. Note generally that points A, B, C, E, and F in FIG. 3 connect to the corresponding points in FIG. 4; the entire network and associated environment are not amenable to illustration on a single sheet.

The acquirer 2006, in the specific example of FIGS. 3 and 4, has at its premises a payment network interface processor (PNIP 2012). The MasterCard Interface Processor or MIP is a non-limiting example of a PNIP. In a non-limiting example, the PNIP is implemented on a rack-mounted server. PNIPs are typically located at the edges of the payment card network. In at least some instances, the payment card network of FIG. 2 is a distributed network wherein each acquirer and issuer has at least one PNIP on their premises. Each acquirer 2006 will have a relationship with one or more merchants 2004 and will interface with the merchants' terminals 126 via terminal driver 2014 (an acquirer may also act as an acquirer for themselves as a merchant). Furthermore in this regard, the merchant locations will have terminals where the cards are swiped (or where contacted or contactless devices are presented). The acquirer will employ terminal driver 2014 to interface with those terminals. Terminal driver 2014 is a logical block representing software and/or hardware that allows the acquirer processing platform 2015 to communicate with the terminals of the merchants via TCP, dial up, or the like (TCP/IP interfaces 2016 are shown in the example in the figures). Each merchant will decide what acquirer to use to accept one or more brands of payment cards, and the acquirer will set the merchant up with the appropriate software and/or firmware for the merchant's point of sale devices.

The acquirer 2006 will present transactions from many different merchants 2004 to the payment card network operator 2008 via the PNIP interface 2012. The connection between the merchants 2004 and the acquirer 2006 is typically a TCP/IP interface 2016. The format that the transaction is in when the card is swiped at the merchant 2004 may differ from the format that the transaction is in when actually received by the payment card network operator. The acquirer may convert the transaction into the ISO 8583 format or into a format that is a specific implementation of the ISO 8583 format (e.g., the MASTERCARD CIS (customer interface specification) format. The authorization request message can be an ISO 8583 message type identifier (MTI) 0100 message, for example, sent over the communications interface 2016 between the merchant 2004 and the acquirer 2006.

Once the 0100 message is received at the PNIP 2012 of the acquirer 2006, a series of edits can be performed on the transaction with respect to format, content, and/or context. Furthermore, screening can be carried out to determine whether the message relates to something beyond an ordinary authorization request, referred to as an enhanced service. Enhanced services may be screened for on behalf of one or more issuers 2010 and/or the operator of network 2008 itself. A centralized member parameter system (MPS) 2018 can be provided to house parameters used to drive processing of credit authorization transactions. In one or more embodiments, extracts from the centralized member parameter system 2018 are distributed to all acquirer PNIPs 2012 and issuer PNIPs 2024 on the network 2008 on a daily basis to drive processing of credit card transactions.

It should be noted at this point that an “ICA” and a “BIN” are employed in BANKNET so that a member can perform card issuing and/or acquiring activities. An ICA or Interbank Card Association is a four to six digit identification assigned by MasterCard for use by a member to uniquely identify activity the member is responsible for. A BIN or Bank Identification Number is a unique series of numbers assigned by MasterCard to a principal member and used as the first six digits of a cardholder account number. Other payment card networks have similar types of numbers, as will be apparent to the skilled artisan.

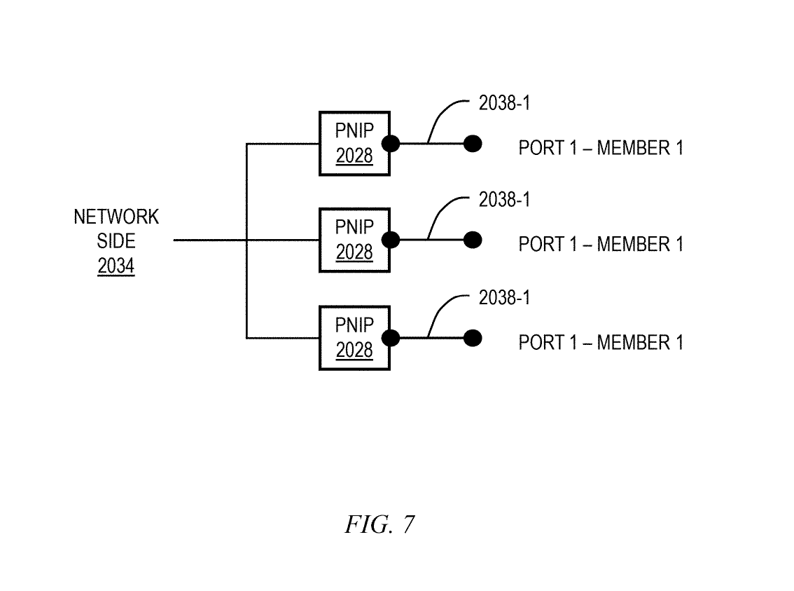

In at least some embodiments, the same member parameter extract is sent to all PNIPs and transactions are routed using same. In at least some circumstances, account numbers or ranges of account numbers are used in deciding how to route. In some cases, transactions are routed to an issuer PNIP based on where the account range is “signed in.” Issuers send an MTI 0800 sign in request message with either a group ID or account range. The Member ID is pulled from the PNIP port 2038 configuration and transactions from that account range are then routed to the port from which the sign-in request is received. A member ID can be present on ports on multiple PNIPs at an Issuer site—see discussion of FIG. 7 below.

In one or more embodiments, based on the account range, the parameters in MPS 2018 (or a local extract thereof) will determine how to process a given transaction; e.g., product code, country code, currency code, and the like, including what enhanced services (if any) the issuer has signed up for on a particular account range. That is to say, the messages are parsed and certain fields, including the account range, are examined; the account range is associated with a certain issuer and based on that, the message may be treated differently. Messages may be parsed, and converted into an internal data format so that access can be obtained to all the individual data elements. In one or more embodiments, the account number is used as a key to access the MPS 2018 (or a local extract thereof) and retrieve all the parameters that are appropriate for processing the given transaction. In a non-limiting example, a suitable message parser 2020 (and other programs on the PNIP 2012) can be written in an appropriate high-level language or the like.

In an exemplary embodiment, the central MPS 2018 creates extracts once a day that are distributed out to the endpoints on the network (e.g., PNIPs 2012), as seen at 2022. These extracts include the pertinent information needed for the PNIP to process the message and determine if it requires any special handling. In some instances, messages are next routed to a central site 2009 for performance of enhanced services. On the other hand, if no special services are required, the message may be routed directly to the issuer PNIP 2024 as seen at 2026.

Messages routed directly to the issuer PNIP: In this aspect, the transaction is routed directly to the issuer PNIP 2024 based on the MPS extract 2022, as seen at 2026. Every account range will have a unique destination endpoint identified in the parameters (account ranges may be grouped and all members of the account range group may have a common destination endpoint). The member interface refers to the connection between the acquirer processor 2006 and the Acquirer PNIP 2012. This term also applies to the interface between the Issuer PNIP 2024 and issuer processor 2010. The connections between and among acquirer PNIP 2012 and issuer PNIP 2024, acquirer PNIP 2012 and ASPs 2050, and ASPs 2050 and issuer PNIP 2024 are referred to as a network interface onto the payment card network itself (elements 2050 are discussed below). In one or more embodiments, this may be a TCP/IP connection (as seen at 2026) with customized routing capabilities including group addresses. Normally, TCP/IP addresses refer to a single endpoint. Group addresses may be directed to a group of addresses, and will target any of the computers (e.g., PNIPs) in the group using a variety of protocols. Some use a round robin approach; others may use a first in list approach where the message is always routed to one given computer first and then to a second computer only if the first is not available. Group addressing may be useful, for example, where an acquirer or issuer has multiple PNIPS at the same location for redundancy/fault tolerance. It is also possible to combine the approach and institute a round robin, wherein the addresses within the round robin are first in list group address, or conversely, it is possible to institute a first-in-list, wherein the addresses within the first-in-list are round robin group addresses. These capabilities are useful in case of outages, maintenance, and the like.

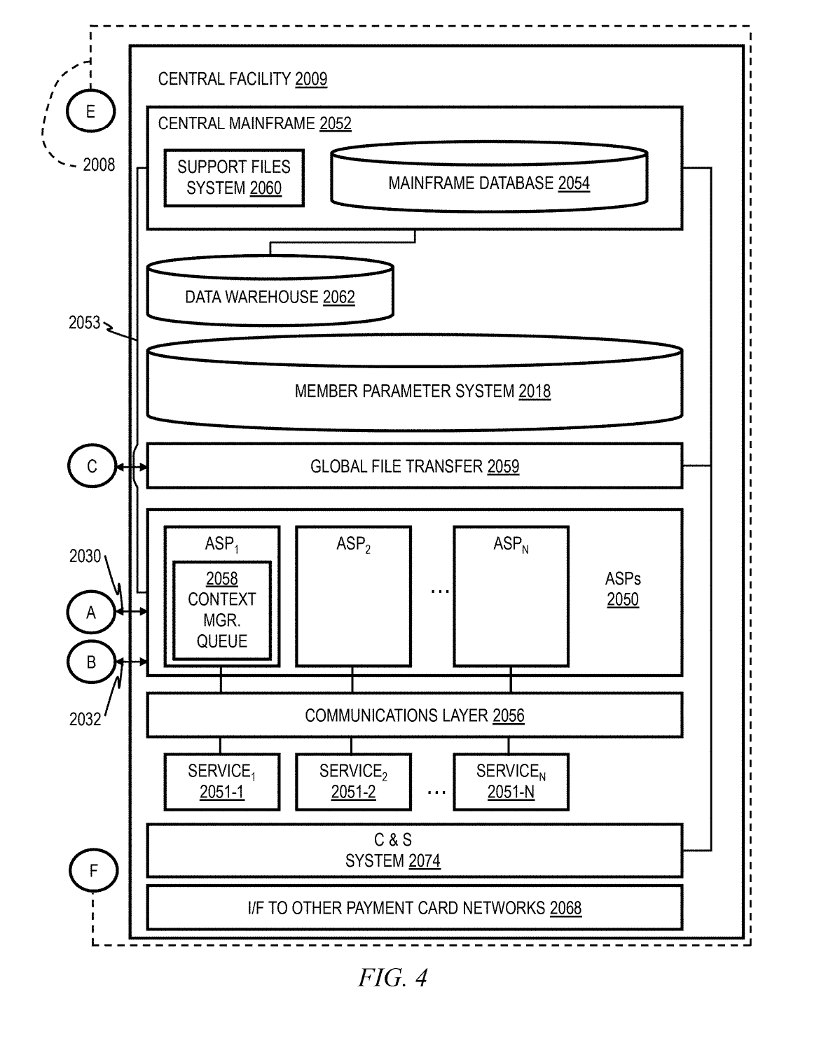

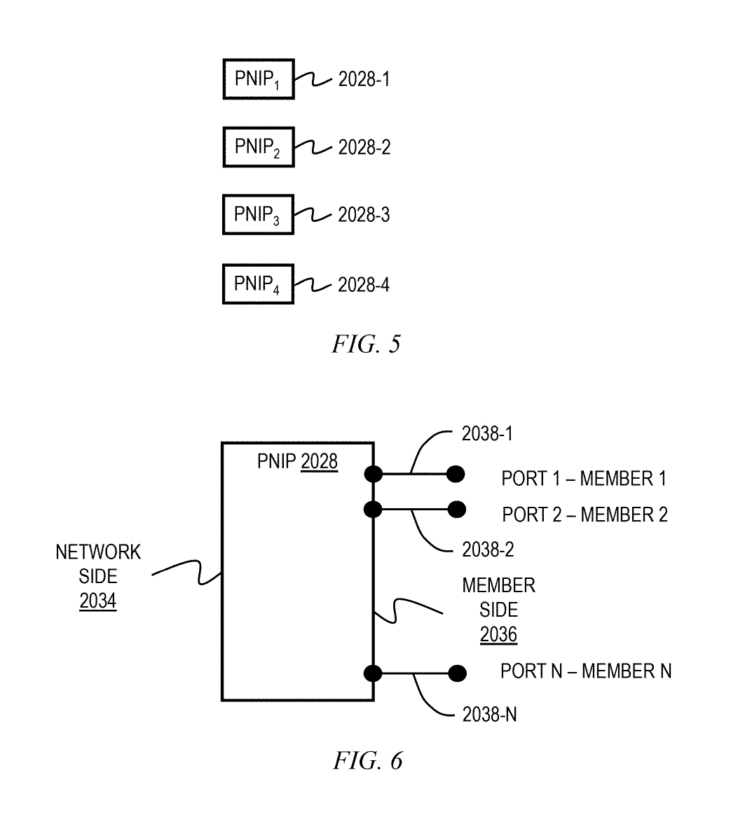

FIG. 5 shows a non-limiting example with four PNIPs 2028-1 through 2028-4. In a round robin approach, a first message is routed first to PNIP 2028-1, a second message to PNIP 2028-2, a third message to PNIP 2028-3, a fourth message to PNIP 2028-4, a fifth message to PNIP 2028-1, and so on. In a first in list approach, all messages are routed to PNIP 2028-1; if it is not available for a given message, the message is routed to PNIP 2028-2; if PNIP 2028-2 is not available, the message is routed to PNIP 2028-3; if PNIP 2028-3 is not available, the message is routed to 2028-4. Each PNIP 2028-1 through 2028-4 in FIG. 5 could be a single machine or a group of machines addressed by first in list or round robin as discussed just above. In one or more embodiments, the physical network 2026 between PNIPs 2012, 2024 and the physical network 2030, 2032 between PNIPs 2012, 2024 and the central site 2009 is a private Multiprotocol Label Switching (MPLS) TCP/IP network and is not the Internet. Once the issuer's network group address has been determined by the PNIP 2012 (or ASP 2050), the message is routed to the issuer PNIP 2024. Once the 0100 auth message arrives at the issuer PNIP 2024, additional edits are performed to double check and make sure that the message has been routed to the correct location. Furthermore, the member ID is examined, because some issuers may share a single PNIP and it is necessary to determine which of the issuers (members) sharing that PNIP the transaction in question is to be routed to. Each of the issuers sharing the PNIP will have its own port on the member side of the PNIP; the transaction is routed to the appropriate port based on the member parameters. See FIG. 6 where a generalized PNIP 2028 has a network side 2034 and a member side 2036. Member side 2036 has N ports 2038-1 through 2038-N to members 1 to N. N is used herein as a generalized arbitrary integer and the value of N in FIG. 6 is not necessarily the same as that of N in connection with elements 2002 in FIG. 2, for example.

As seen in FIG. 7, in some instances, an issuer has multiple PNIP devices 2028 at a single site, with a network-side connection 2034, and with multiple PNIPs 2028 all connected to the same host system (each has port 1 2038-1 associated with the same member (issuer)).

At this point, the 0100 message has been delivered to the issuer 2010. The issuer 2010 then carries out issuer processing and decisioning (e.g., with issuer processing platform 2040) based on transaction velocities, open to buy, fraud detection protocols, etc., and provides an appropriate authorization request response, ISO 8583 MTI 0110. There are a number of different possible response codes defined within ISO 8583 and its particular implementations. Each transaction is made up of multiple data elements; the response from the issuer is included in data element 39. Once the 0110 message is received on the issuer PNIP 2024 from platform 2040 it is parsed and edited for format, content, and context, including validation of DE39 to make sure that it is a valid value.

It is worth noting that in one or more instances, at every point where a transaction touches a computer of the payment card network, whether it be an acquirer PNIP 2012, issuer PNIP 2024, or a special services computer or computers 2050 at the central location 2009 (discussed below), transaction context is preserved. That is to say, before the message is sent on to the next node in the network, a copy is saved in a context manager queue 2042, 2046, 2058, so that when the transaction response MTI 0110 comes back through, the request MTI 0100 can be matched with the response, in order to know how to route the response back to the previous route point. One of the items saved in the context manager queue is the message originator's address, so that it can be used for route-back information. Once the issuer PNIP validation is complete, including format, content, and context edits, the transaction is extracted from the context manager queue 2046 and the route-back address is retrieved, and the 0110 message is then sent back where it came from; in this case, the acquirer PNIP 2012 (or ASP 2050). The acquirer PNIP 2012 then receives and parses the message and pulls its original request out of its context manager queue 2042. Note that multiple acquirers may share an acquirer PNIP and it is therefore necessary to know which port on the acquirer PNIP to route the response back to (see discussion of FIG. 6). Checking the message against the original request in the context manager queue allows the message to be routed back to the correct port.

Each PNIP 2012, 2024 typically has many different programs. These can include, for example, a parser/editor 2020, 2043; a parameter file manager; a transaction context manager; a member communications program; a network communications program; and the like. Please note that to reduce clutter, FIGS. 3 and 4 show “MPS extract” 2022, 2044; this will typically include the extract itself and the associated parameter file manager which manages obtaining the extracts from MPS 2018. Similarly, to reduce clutter, FIGS. 3 and 4 show “context manager queue” 2042, 2046; this will typically include the queue itself and the associated manager which manages the contents of the queue. In one or more embodiments, there is also a communication program used to communicate between the other programs (inter-process communications) on the PNIP; this is omitted from FIGS. 3 and 4 to avoid clutter.

Messages in case of Enhanced Services: In one or more instances, a special architecture is used to facilitate delivery of enhanced services (the ASP 2050 in FIG. 4 is a non-limiting example). Examples of enhanced services include the MASTERCARD IN CONTROL product providing spending controls and/or virtual card numbers (MASTERCARD IN CONTROL is generally representative of spend control systems, card control systems, and the like, and embodiments indicated as employing MASTERCARD IN CONTROL are not intended to imply any limitation to one particular spend control and/or card control system). Other examples of enhanced services are loyalty rewards, recurring payment cancellations, and the like. One or more instances do not deploy this complex logic out to the network edge. Furthermore in this regard, the issuer and acquirer PNIPs 2012, 2024 are referred to as being on the edge because they reside on the customer's premises 2006, 2010. There may be over 2000 PNIPs on a typical network. The special architecture used in one or more instances is a central site type architecture associated with location 2009. At the central site 2009, certain computers are referred to as authorization services processors or ASPs 2050.

On the acquirer PNIP 2012, when checking the member parameter file for an account range, determine whether the transaction requires enhanced services. If yes, the transactions is routed to the central site ASPs 2050, which have interfaces to all of the service provider systems—the ASPs do not necessarily provide the services themselves (although they can in some embodiments), but may mediate between the network (e.g., BANKNET) and the actual service providers 2051-1 through 2051-N. An ASP will typically have connections 2053 to a mainframe 2052 via DB2 connect or other suitable connection. If a transaction is to be enriched with additional data, a database call will be made to the mainframe 2052 to retrieve the information from mainframe database 2054 so that it can be inserted into the transaction before the transaction is forwarded to the issuers. Interfaces can also be provided to a risk management system, a decisioning management system, MASTERCARD IN CONTROL, rewards, and the like. Service providers 2051-1 through 2051-N generally represent any enhanced services, non-limiting examples of which have been given herein.

A communications layer 2056 is used to communicate with the service providers in one or more embodiments, a non-limiting example of a suitable implementation is the IBM MQ series. The 0100 message may be sent to the service providers, optionally encapsulated inside a special “enhanced services” (ES) header that wraps the message with any additional information required to fulfill the service. The service provider sends a response. The ASP takes the response and enriches the 0100 transaction with the service response, and then sends the entire package on to the issuer PNIP 2024. Some enhanced services are processed on the request messages (0100) and others are processed on the response messages (0110). Once the response message is processed on the ASP, the original message will be pulled from the context manager queue 2058 on the ASP to determine the appropriate acquirer PNIP 2012 to route the message back to. From there, the acquirer PNIP will behave just as in the “Messages routed directly to the issuer PNIP” case discussed above. Some embodiments of the special architecture use an Enterprise Service Bus to mediate and facilitate some of the services 2051. For example, the MASTERCARD IN CONTROL service can be accessed via an instance of an Enterprise Service Bus.

Entry of Data into the Data Warehouse: In one or more instances, every transaction that flows through the issuer PNIP 2012, acquirer PNIP 2024, and/or ASPs 2050 is logged at every point by writing log records. Multiple times a day (e.g., six), a global file transfer system 2059 pulls the logs off each node and collects them into a support files system 2060 on the mainframe 2052. The log files are parsed and collected into a general daily file. The general daily file is scrubbed and modified to create a consolidated file on the mainframe which is then pulled into the data warehouse 2062, where additional data manipulation and scrubbing are performed before the transactions are stored. The data warehouse 2062 is located at an intermediate node (location 2009) connected to the PNIPs of the acquirers and issuers 2012, 2024. By way of clarification, in one or more embodiments, the node 2009 is directly connected to the PNIPs 2012, 2024 but the data warehouse is not directly connected to the 2012 and 2024 devices; rather, data flows through GFT and SF systems 2059, 2060 and ends up in the data warehouse. Data warehouse 2062 should be distinguished from a data warehouse 154 that might be maintained by an issuer.

Clearing and Settlement: One or more instances employ a clearing and settlement system 2074. In clearing, via global file transfer 2059, acquirers submit clearing files in an appropriate message format (in a non-limiting example, Integrated Product Messages (IPM) format). The files contain, from the acquirers' perspective, what they believe they should be paid for. In one or more instances, the authorization does not actually move any money; the authorization only validates that the cardholder is a valid cardholder recognized by the bank, which will honor payment to the merchant for the goods or services. For example, in a typical restaurant visit, the card is swiped for the receipt amount but then a tip is added. The clearing message will have the actual food amount plus the tip. In one or more instances, the clearing does not actually move the money; it merely resolves the actual amounts. The settlement system actually initiates movement of the money. Furthermore in this regard, the settlement system actually tells the banks how much money to move but does not actually move the money. Within clearing, processes include dispute resolution, chargeback, and the like. During clearing, files are sent from the acquirers to the payment card network; the payment card network, using clearing and settlement system 2074, then takes the files and splits them and sorts them by issuer. Response files are then received from each issuer, and these response files are again split and re-sorted back to the correct acquirers. Eventually, data flows into the settlement system and money is moved. Thus, at a high level, the auth request and auth request response are in real time, and the clearing and settlement are in a batch mode.

By way of review and provision of additional detail, in at least some instances, in a batch mode, clearing is initiated via an ISO 8583 MTI 1240 message having a DE24 function code value of 200 for a first presentment. Once this message is obtained from the acquirer, the payment card network, using clearing and settlement system 2074, will undertake syntax edits, format edits, content edits, and context edits (typically applied to every transaction). If those edits are passed, the interchange and fees associated with the transaction will be calculated. Based on the calculations, the message may also be enriched with additional information before being passed on to the issuer. The settlement amount is then determined. Within the clearing cycle, the amounts of money due to each given member (e.g., issuer or acquirer) are accumulated, and these are summed up into a settlement file which is forwarded in due course.

Cryptographic aspects: Consider the concepts of data at rest and data in motion. An example of data at rest is the log files that actually reside on the PNIPS themselves—configuration information containing card numbers or personally identifiable information (PII). In one or more embodiments, all sensitive data at rest is encrypted before being written to disk. Data in motion refers to data actually moving over a transmission medium (e.g., wires, coaxial cable, fiber optic cable, RF link). All PCI-sensitive data (PCI Security Standards Council, LLC, Wakefield, Mass. U.S.) is encrypted, whether written to disk or being sent over a network. In at least some instances, internal links within the premises of the acquirers and issuers are not encrypted since it is assumed that the customer premises are a physically secure facility relying on physical security of the hardware. On the other hand, in at least some instances, external links (e.g., links 2026, 2030 and 2032) are all encrypted for both authorization traffic and bulk file transfers.

One or more embodiments will have interface(s) 2068 to other brands of payment card processing network. For example, a MASTERCARD branded payment card processing network may have interfaces to networks such as AMERICAN EXPRESS, VISA, JCB, DISCOVER, and the like. Suitable translation layers can be provided to intermediate between MASTERCARD (or other) format and formats used by other networks, as appropriate. In one or more embodiments, interfaces 2068 to other payment networks are provided via a machine, located at 2009, but generally analogous to an Issuer PNIP 2024 with added mediation layers loaded as required by other payment network formats. Some merchants may only have a single interface to, e.g., the MASTERCARD network—all transactions from that merchant may be routed to MASTERCARD, regardless of what card was used—MASTERCARD will process those transactions and route them out to the appropriate networks.

### Conventional Closed-Loop Transit System Using Proprietary Fare Cards

FIG. 9 shows a closed-loop transit system using proprietary fare cards, as known from the prior art. A rider (not shown) presents proprietary fare media 9010 at an entrance turnstile and reader 9006 in order to gain access to the transit system 9000. A closed-loop authorization system communicates with transit server 9002 to determine whether the rider should be allowed in. Server 9002 looks up the records associated with media 9010 in database 9004 to determine if the rider should be allowed through the turnstile 9006. For example, server 9002 may check whether there is adequate monetary value stored in database 9004; whether an adequate number of rides remain in the records in database 9004; or whether the current week, month, etc. has run out (in each case depending on the kind of fare structure employed). While referred to as an account database, there could merely be records for each individual fare card or other media. Optionally, the rider presents the fare card or other media 9010 again upon exiting via exit turnstile and reader 9008 (e.g., for a distance-based fare). A rider purchases proprietary fare media 9010 and adds value to it at a kiosk or from a human in a booth, for example.

Note that in general, in transit systems, there is generally a requirement to quickly decide whether a rider is to be allowed through the turnstile—for example, a time of 200-500 milliseconds may be appropriate.

The operator of the transit system 9000 may employ rudimentary measures to prevent counterfeiting of proprietary fare media 9010.

### Conventional Closed-Loop Transit System Using Widely-Accepted Payment Devices as Tokens, Without Conventional Payment Device Processing

Some systems work in a manner similar to FIG. 9, except that they employ widely-accepted payment devices (e.g., payment cards) in lieu of proprietary fare media 9010. For example, the Chicago Transit Authority employs the Ventra™ (mark of Chicago Transit Authority, Chicago Ill.) contactless debit MasterCard. However, the VENTRA cards are used primarily as tokens in the same manner as the proprietary fare media in FIG. 9; there is no authorization request to the issuer and response from the issuer associated with VENTRA card transit use (compare to the conventional authorization request and response described with respect to FIGS. 2-4, for example).

Conventional Closed-Loop Transit System Using Widely-Accepted Payment Devices as Tokens, with Conventional Payment Device Processing

Co-assigned U.S. Pat. No. 8,584,936 discloses techniques for authorization of usage of a payment device. The payment device has an associated account number and is issued by an issuer coupled to a payment processing network. In some embodiments, the account number is obtained in connection with a putative transaction with a terminal of a transit authority, and it is determined whether the account number is in an active file of the transit authority which indicates whether the account number is known to the transit authority. If the account number is not in the active file, such that the account number is not known to the transit authority, an authorization message is sent to the issuer through the payment processing network, and an issuer authorization decision is obtained. However, as long as any desired local checking is carried out successfully (e.g., checking against a local list), the rider is allowed to board without waiting for the issuer authorization decision (to allow quick decisioning). If the issuer authorization decision is affirmative, a desired amount (e.g., to establish a balance to cover a certain number of rides) is charged to the account associated with the payment device, and the device is used as a token to access the transit system, with periodic replenishment of the balance. If the issuer authorization decision is negative, further rides are not permitted.

### Authentication in an Open-loop Environment—On-Line EMV

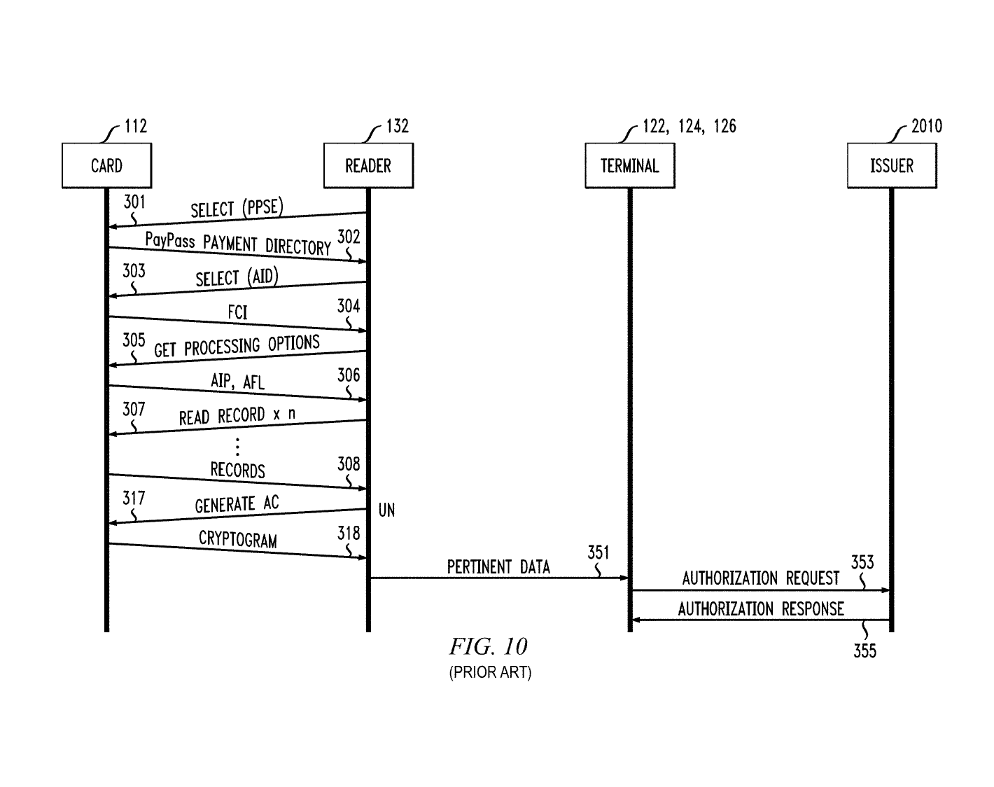

Reference should now be had to FIG. 10, which depicts a standard EMV transaction flow. The complete disclosure of US Patent Publication No. 2009-0103730 is expressly incorporated herein in its entirety for all purposes. In a normal transaction, in a zeroth step (not illustrated), the reader 132 and card 112 (understood to include other kinds of devices, as well—throughout this specification, descriptions of smart “cards” are equally applicable to other smart payment devices, unless indicated otherwise), establish communications. Note that the reader may be a peripheral device of the terminal (e.g., 122, 124, 126), which performs the interaction with the card. It should be noted that in some instances, the terminal and reader are integrated into a single point-of-sale (POS) device while in others, they may be separate. Furthermore, in some instances, the terminology “terminal” is used as shorthand for the reader and terminal together; the skilled artisan will appreciate this from the context. In some instances, the functionality can be incorporated into the reader rather than requiring changes to the terminal.

In a first step 301, the SELECT (PPSE) command allows the reader 132 to find out what payment applications the card has. This information is returned in the MASTERCARD CONTACTLESS PAYMENT DIRECTORY in step 302. In step 303, the reader selects an appropriate one of the applications using the SELECT command with the appropriate application identifier (AID) as an argument. Step 304 includes the return of FCI—File Control Information from the selected payment application. The FCI data may also specify the PDOL—Processing Data Objects List, which is data that the card needs from the reader in order to conduct the transaction as defined immediately hereinafter for step 305. In step 305, if the card asked for any specific data in step 304, the reader sends it in step 305, via the GET PROCESSING OPTIONS command. This step “says” to the card “tell me the basic context for the transaction. What do I need to read from you and what process shall we use?” The various commands and arguments are familiar to the skilled artisan from the EMV, MasterCard Contactless M/CHIP® & MasterCard Contactless MAGSTRIPE standards (registered marks of MasterCard International Incorporated, Purchase, N.Y., USA). Step 306 includes the card responding to the GET PROCESSING OPTIONS command telling the reader the information that it needs for the transaction—AIP (Application Interchange Profile) tells the reader how to conduct the transaction, while AFL (application file locator) tells the reader what records need to be read from the card in order to conduct the transaction.

In steps 307 (representing “n” READ RECORD commands), a large amount of data is read from the card, using the series of READ RECORD commands, in a manner well-known in the art. Step(s) 308 show(s) return of the records that have been read.

In step 317, the reader provides an unpredictable number (UN), and transaction details (including Amount and Currency Code) and asks the card to compute an application cryptogram (in EMV, this is done using the GENERATE AC command). In step 318, the card responds with an application cryptogram that allows the transaction to be completed. In addition, the reader can obtain a certified copy of the card's public keys from the READ RECORDS, and can then optionally ask the card to sign the transaction in step 317, giving a signature over the transaction data in steps 317 and 318 that the terminal can check.

The process just described will now be reiterated and summarized. There is an initial exchange where the card and reader work out how to communicate and establish communication. Then, the application is selected at 303, wherein a “SELECT” command is sent from the reader to the card, giving the card the identity of the application the reader wants to select. The reader gets a response from the card at step 304 that says (the terms “say,” “talk,” and the like being understood to contemplate electronic communication), in essence, “here is a brief description of the card application.” The reader then sends the “GET PROCESSING OPTIONS” command to the card in step 305. This is, in colloquial terms, the reader saying to the card “I would like to conduct a transaction; let us work out the details of how we should proceed”; the reader says to the card “if you asked for any details to determine how we should communicate, here are those details,” and the card says to the reader, in step 306, “here is the information that you need in order to know how to proceed with the transaction.” The information basically tells the reader what to read from the card and what the context of the transaction is.

In step(s) 307, the reader takes from the card all of the information it needs, via a series of instructions called “READ RECORD.” The data obtained includes the primary account number (PAN), expiry date, track data, and a series of RSA certificates that allow verification of the authenticity of the card's data. The data obtained may also (optionally) include a PAN Sequence Number which in combination with the PAN uniquely identifies the card.

The application cryptogram returned in step 318 may be based, in part, on the application transaction counter (ATC), which is a counter in the chip card, two bytes long, which increments every transaction, and is a fundamental security mechanism employed with both contacted and contactless chips. It is one wherein the card and issuer can ensure that cryptograms received from the card are not “old” cryptograms; i.e., the ATC can be used to ensure that a cryptogram produced by the card is not a previous cryptogram. Stated in another way, one of the things that would not be desirable is for a card to produce the same cryptogram that it produced for a previous transaction. By including the ATC in the cryptogram, it is ensured that the card will never produce a cryptogram that is the same as a previously-produced cryptogram.

In addition, the skilled artisan will appreciate that the unpredictable number (UN) sent in step 317 is a four-byte number which provides a way for the terminal to ensure that the transaction is not replayed but rather is fresh. It is part of what is known as a challenge and response protocol, wherein the terminal sends an unpredictable number to the card, and the card will include that number in its cryptogram, which is sent to the issuer for authorization or clearing. In parallel with that, the terminal sends the unpredictable number to the issuer, and the issuer uses same as part of verifying the cryptogram.

As shown at 351, pertinent data (typically, a suitable card identifier, account-related data, and transaction-related data) is supplied by the reader to the terminal for inclusion in the authorization request or clearing record. For online card authentication, the cryptogram generated by the card that is included in the pertinent data is an ARQC (Authorization ReQuest Cryptogram); it is included in an authorization request sent to the issuer 2010 at 353. The authorization request 353 and response 355 may conform, for example, to the ISO 8583 standard (proprietary sub-elements may also be included in some cases, as will be appreciated by the skilled artisan).

Thus, the ARQC is a cryptogram used for online card authentication; it is generated by the card for transactions requiring online authorization. It is the result of card, terminal, and transaction data encrypted by a Data Encryption Standard (DES) key. It is sent to the issuer in the authorization 353. The issuer validates the ARQC to ensure that the card is authentic and card data was not copied from a skimmed card. The ARPC (Authorization ResPonse Cryptogram) is a cryptogram used for online issuer authentication. This cryptogram is the result of the ARQC and the issuer's authorization response encrypted by a DES key. It is sent to the card in the authorization response 355. The card validates the ARPC to ensure that it is communicating with the valid issuer.

### Authentication in an Open-Loop Environment—Off-Line EMV

The preceding section describes an “online” transaction where communication with the issuer host takes place in real time. With the more recent chip-based cards (as opposed to cards whose only means of electronic data storage is a magnetic stripe), this typically provides a strong cryptographic check that the card is genuine. In an “offline” transaction, communication with the issuer host does not take place in real time (although there is ultimately a communication with the card issuer; i.e., the processing is ultimately open loop and not closed loop) and a local decision must be made regarding whether the transaction is to be permitted. As noted, with some kinds of payment cards or other payment devices a cryptogram can be validated offline by the terminal to provide offline authentication; other types of chip-equipped payment cards or other payment devices require going online to contact the issuer host to carry out authentication. In essence, the card and the terminal agree how they can best authorize the transaction. EMV and offline cardholder authentication methods allow a card and terminal to either approve a transaction offline (based on risk management parameters set by the issuer) or seek authorization online in the event that the transaction cannot be authorized or completed offline.

Several different types of offline authentication of the card or other device can be carried out. In this regard, offline data authentication is a cryptographic check to validate the card using public-key cryptography. There are three different processes that can be undertaken depending on the card:
Static data authentication (SDA) ensures data read from the card has been signed by the card issuer. This prevents modification of data.
Dynamic data authentication (DDA) provides protection against modification of data and cloning.
Combined DDA/generate application cryptogram (CDA) combines DDA with the generation of a card's application cryptogram to assure card validity.

In each case, communication with the issuer is not currently required for authentication (although, as noted, there is ultimately a communication with the card issuer at a later time). Note that the security level provided by SDA is even further enhanced by DDA; the latter is in turn even further enhanced by CDA. Some systems may not accept SDA as a valid form of offline authentication and may therefore seek to force the transaction to go online.

### Authentication in an Open-Loop Environment—On-Line Chip Card Emulation of Magnetic Stripe

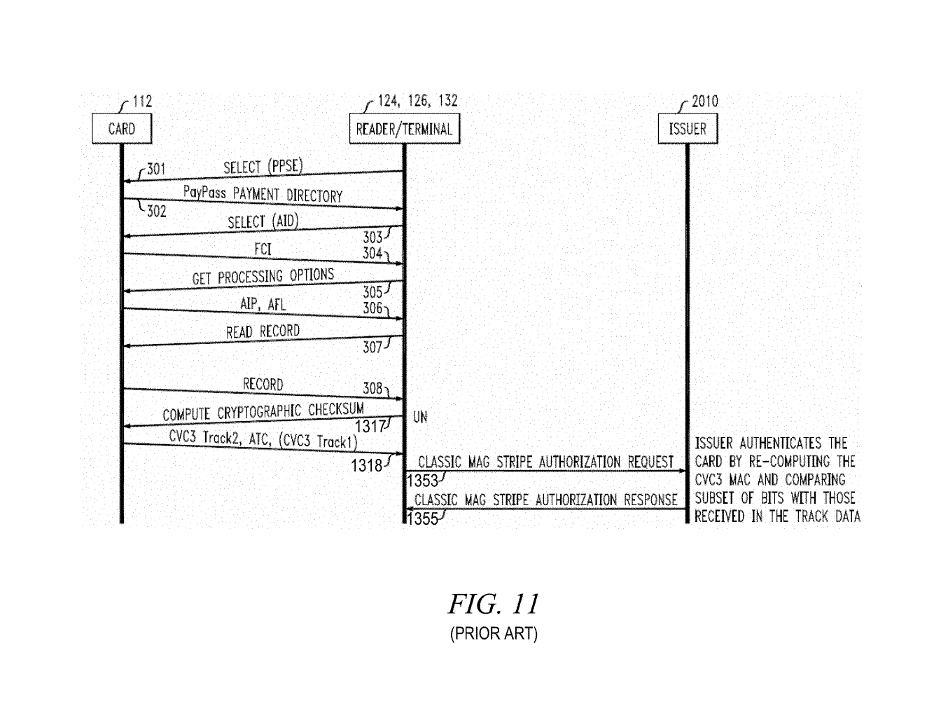

Giving attention now to FIG. 11, an example will be given of a MasterCard Contactless MAGSTRIPE PROFILE transaction. In such a transaction, in a preliminary step (not illustrated), the reader 132 and card 112 (understood to include other kinds of devices, as well), establish communications. Note that reader 132 was discussed somewhat generically above, but in the context of FIG. 11 includes at least a contactless reader. In other cases, a contact reader can be provided. In a first step 301, the SELECT (PPSE) command allows the reader 132 to find out what payment applications the card has. This information is returned in the MASTERCARD CONTACTLESS PAYMENT DIRECTORY in step 302. In step 303, the reader selects an appropriate one of the applications using the SELECT command with the appropriate application identifier (AID) as an argument. Step 304 includes the return of FCI—File Control Information from selecting Proximity Payment Systems Environment (PPSE). Step 306 includes the card responding to the select application command telling the reader the information that it needs for the transaction—AIP (Application Interchange Profile) tells the reader how to conduct the transaction, while AFL (application file locator) tells the reader what records need to be read from the card in order to conduct the transaction. It may also specify the PDOL—Processing Data Objects List, which is data that the card needs from the reader in order to conduct the transaction as defined immediately hereinafter for step 305. In step 305, if the card asked for any specific data in step 304, the reader sends it in step 305, via the GET PROCESSING OPTIONS command. This step “says” to the card “tell me the basic context for the transaction. What do I need to read from you and what process shall we use?” The various commands and arguments are familiar to the skilled artisan from the EMV, MASTERCARD CONTACTLESS M/CHIP® & MASTERCARD CONTACTLESS MAG STRIPE standards (registered marks of MasterCard International Incorporated, Purchase, N.Y., USA).

In step(s) 307, data is read from the card, using the READ RECORD command, in a manner well-known in the art. Step 308 shows return of the records that have been read.

In step 1317, the reader provides an unpredictable number (UN) and asks the card to compute a cryptographic checksum. In step 1318, the card responds with the track 1 CVC3 (optional), the track 2 CVC3, and the Application Transaction Counter (ATC). Note that CVC=card verification code.

The process just described will now be reiterated and summarized. There is an initial exchange where the card and reader work out how to communicate and establish communication. Then, the application is selected at 303, wherein a “SELECT” command is sent from the reader to the card, giving the card the identity of the application the reader wants to select. The reader gets a response from the card at block 304 that says (the terms “say,” “talk,” and the like being understood to contemplate electronic communication), in essence, “here is a brief description of the card.” The reader then sends the “GET PROCESSING OPTIONS” command to the card in step 305. This is, in colloquial terms, the reader saying to the card “I would like to conduct a transaction; let us work out the details of how we should proceed”; the reader says to the card “if you asked for any details to determine how we should communicate, here are those details,” and the card says to the reader, in step 306, “here is the information that you need in order to know how to proceed with the transaction.” The information basically tells the reader what to read from the card and what the context of the transaction is.

In step(s) 307, the reader takes from the card all of the information it needs, via a command called “READ RECORD.” The data obtained includes the primary account number (PAN), expiry date, and track data. In some instances, the data obtained may also include a series of public key certificates that allow verification of the authenticity of the card's data and encryption of data sent to the card (e.g. confirmation that a PIN entered into the reader by the cardholder was successfully verified by the card).

In step 1317, the reader provides an unpredictable number (UN) and asks the card to compute a cryptographic checksum.

Still with reference to FIG. 11, the reader 132 and the terminal 124, 126 are depicted as a single entity in this instance.

The track 2 data, and the track 1 data if provided, are sent to the issuer host 2010, as shown at 1353, within a conventional magnetic stripe authorization request. The conventional magnetic stripe authorization response is depicted at 1355. Note “Classic Mag Stripe” is intended as a non-limiting example of conventional magnetic stripe messaging.

### Authenticating Payment Credentials in Closed Loop Transaction Processing

Consider that the majority of transit merchants around the world manage their fare collection processes by requiring pre-payment of fares before a commuter initiates his or her travel journey through that transit environment (e.g. subway, bus, ferry, rail, and the like). Coin-based tokens, cash, or the purchase of limited use fare media (in the form of magnetic stripe (e.g., New York MetroCard) or contactless (e.g., London Oyster) cards) are the most popular methods by which a commuter pays for his or her fare.

Since September 2013, the Chicago Transit Authority has operated a fare collection system that accepts contactless and open standard payments at the fare gate & fare box. The design of the payment system is such that the majority of the fare transactions (about 95%) are closed-loop processed using a closed-loop prefunded approach. This constitutes a hybrid of closed & open loop acceptance. The open standard credential is being used, tokenized and processed in a closed loop manner where the back office accesses a second account that the commuter can top up separately; the second account is different than the original account associated to the PAN of the payment credential.

Furthermore in this regard, in the current Chicago Transit Authority solution employing the VENTRA cards, the VENTRA cards are MasterCard brand prepaid cards but they have two accounts associated with each card (and two purses). In particular, there is the MasterCard brand prepaid account (balance stored on a server associated to the issuing bank of the card) and also a closed loop transit account (“shadow” transit account). Even though the VENTRA cards are MasterCard brand prepaid cards, when used within the Chicago Transit Authority, they do not by default transact to the associated MasterCard brand prepaid account, but rather to the balance held in the “shadow” transit account that is tokenized (associated to the PAN of the VENTRA MasterCard brand prepaid card). The MasterCard brand prepaid account and the closed loop “shadow” transit account are separate accounts with separate balances and separate topping-up methods (i.e., they are topped up in different locations and in a different manner).

In this approach, the system does not authenticate the open loop credential in the same manner that an open standard payment product does (e.g. dynamic CVC3 (DCVC3) or ARQC validation as discussed above). Not validating these credentials in the manner that the technology defines leaves the hybrid acceptance model vulnerable to the possibility of fake or compromised PANs being used in the system. For example, consider a near-field communication (NFC) smartphone, where the user has installed a mobile app that provisions legitimate PANs or randomly generated PANs to the secure element or in the cloud (HCE—host card emulation—MasterCard Cloud-Based Payments is a non-limiting example). If the same does not contact the issuer for verification and does not perform any know your customer (KYC) activity, the phone may be presented to the POS at the fare gate/box and potentially instigate fraudulent activity.

About 5% of the current fare transactions in the Chicago Transit Authority are open-loop transactions with communication out to an issuer to process the fare in a convention al manner (e.g., via MasterCard's BANKNET, Visa's VISANET, or the like). However, in such cases, validation typically occurs in a delayed fashion based on dynamic CVC3 data in the authorization request sent to the issuer host.

One or more embodiments advantageously authenticate these credentials (smart cards, wearable devices, and/or NFC-enabled phones) prior to their being used for closed loop processing. One or more embodiments advantageously provide a service to a transit vendor and/or transit agency, wherein the open standard (open loop) credentials used in the closed-loop transactions (closed loop processing in a closed loop environment-currently about 95% in the non-limiting example of the Chicago Transit Authority) are validated as legitimate credentials that have not been cloned, spoofed, or compromised, rapidly and within the closed-loop transit environment (currently there is no robust validation for these credentials). This service can also be useful for the open-loop transactions with communication out to an issuer to process the fare in a conventional manner (currently about 5% in the non-limiting example of the Chicago Transit Authority) because the credentials used in those transactions can also be validated as legitimate credentials that have not been cloned, spoofed, or compromised, rapidly and within the closed-loop transit environment, rather than having to wait for a communication with the issuer. Thus, in a non-limiting exemplary embodiment, all transactions, whether closed loop or with communication out to an issuer, are authenticated to gain confidence that payment and access credentials are safe and it is acceptable to proceed with the given fare transaction.

This advantageous authentication can be achieved in several ways; by way of example and not limitation:
If the payment device is a chip-based contactless device, the device can authenticate itself.
If the payment device is a magnetic stripe contactless device (e.g. MASTERCARD CONTACTLESS MAG STRIPE-using chip card in mag stripe infrastructure), two non-limiting exemplary possibilities include:
   A local authentication solution that is engaged to authenticate the credentials, prior to sending for closed loop processing.
   An off-site authentication solution that is engaged to authenticate the credentials, prior to sending for closed loop processing. This solution advantageously performs this action sufficiently quickly to keep within the overall time benchmark of 500 milliseconds (typical requirement for end-to-end processing in a high-throughput metropolitan-sized transit environment).

Furthermore in this regard, a card issued just for transit agency use may be the preferred form of access in some cases. If such cards are limited to one BIN, carrying out local authentication of a single popular BIN may be feasible. Based on the credentials, either an authentication action occurs at the POS level or an authentication action occurs with the credential being sent through to the server or potentially to the issuer. However, because of the typical 500 millisecond requirement, a server based rather than issuer based approach will typically be preferred.

Whatever the method, this service can, in one or more non-limiting exemplary embodiments, be offered for a fee per validation.

Thus, today, there are a number of transit operators who perform contactless transactions in the contactless transit space. They currently do not perform some of the authentication, risk management, and/or risk decisioning that a normal contactless device would perform. One or more embodiments provide the transit operators with the capability of performing an authentication validation of a transaction, using open-loop payment card contactless technology within the transit authority's closed loop environment. In some current techniques, transit operators initiate an authorization request for a transaction, send same to an issuer, and the issuer approves a value for the open-loop payment device used in the transit space, in an authorization request response. The issuer authorization request response is used as an issuer confirmation that the open-loop device is valid and can be used in the transit environment. The transit operator effectively uses that device as an identifier to allow the cardholder to operate within the transit operator's environment. There is currently a lack of authentication within the transit operator's environment—transit operators permit use of contactless open-loop devices within their environments without performing secure authentication and/or verification of the devices. One or more embodiments advantageously permit validation and authentication of contactless devices when used within closed-loop transit operator environments.

Currently, (1) closed loop processing of proprietary media or open-loop devices; and (2) authentication and validation of open-loop devices during open-loop processing, with the concomitant security provisions, exist in a separate, stand-alone manner. One or more embodiments provide technology to meld these two aspects. Heretofore, when a transaction is closed-loop processed, even when an open-loop device is used, the operator of the open-loop payment card network is not exposed to the processing. That is to say, for example, if a Ventra MasterCard is used in the Chicago Transit Authority's closed-loop environment, there is no corresponding transaction associated with the primary account number (PAN) of the Ventra MasterCard within MasterCard's BANKNET payment card network; the Ventra MasterCard is used solely as a closed-loop token; funding is, for example, via cash or another payment card. What is being funded is a back office separate account that is different from the PAN on the Ventra MasterCard. The rider can add value to the account, or purchase a time-based fare such as a daily pass, weekly pass, or monthly pass. Once the rider purchases or adds value, via a vending machine or web site, he or she taps the Ventra MasterCard at the turnstile or bus. The Ventra MasterCard PAN is taken to the POS reader, is tokenized by the system, and the back office (e.g. server 9002) correlates the tokenized value to a specific profile (e.g. in database 9004) that has a monetary balance as well as information on whether the rider has a time-based fare (monthly, daily, etc.). Once confirmed with the back-office system, the transit system knows that the credentials and fare have been validated and this profile is in good standing. This happens after the person goes through the turnstile as it can't be done in ½ second.

As noted, in many current transit environments, it is desired to make an entrance decision in ½ second or less (i.e., allow passenger past turnstile or onto bus). Within the closed-loop environment, vendor validation has worked well from the pre-funded standpoint. However, as open loop credential processing and closed-loop processing converge, there is a security concern because vendors do not validate at the same level that operators of open-loop payment card networks validate with their products. Note that the vendor in this context is the entity providing the proprietary/closed loop solution to transit authority, which entity may also be providing an open-loop solution as well. Refer to the discussion above about the robust validation and/or authentication available in the open-loop environment, to authenticate that the payment device is a legitimate, originally issued device and has not been “skimmed.”

Currently, robust open-loop validation and/or authentication typically results in an ISO 8583 0100 auth request going to the issuer with an ISO 0110 auth request response returned (although in the case of aggregation, there is typically not a one-to-one correspondence between device presentation and auth request/auth request response messaging; while in the case of pre-funding, auth request/auth request response messaging may occur prior to presentation). More generally, in current techniques employing robust authentication, there will be, or already has been, a communication with the issuer, whereas in one or more embodiments, robust authentication occurs locally.

Currently, when open-loop credentials are used in a closed-loop environment, because robust open-loop validation is not being carried out, there is fraud risk. In one or more embodiments, that same card can be presented to the fare box and, depending on whether the card's chip is configured according to the EMV standard or the Mag Stripe contactless standard, there are several possibilities.

(i) If the card's chip is configured according to the EMV standard, the card itself can carry out offline data authentication. In this aspect, an offline EMV approach is employed, and if successful, closed-loop business as usual processing ensues.

(ii) In the case of a Mag Stripe contactless card presented to the POS, carry out dynamic CVC3 validation. In this aspect, use DCVC3 as above but messages 1353/1355 to/from the issuer are replaced with something done within the closed-loop transit environment, and then if successful the rest is closed-loop business as usual processing.

In both cases (i) and (ii), there is no MasterCard auth or clearing being done—the devices are used only as tokens, not payment devices. Other aspects are discussed elsewhere herein.

One or more embodiments advantageously address both fraudulent rides and fraudulent accounts.

It is worth noting that heretofore, there has been limited concern with validation in the closed loop transit environment using proprietary fare media, since the media being presented are sequestered for use in the limited acceptance space of transit—attempts to use proprietary cards elsewhere will not work.

It will be appreciated that there are a number of challenges in using open loop credentials in the closed loop transit environment—the technical solutions and business models are diametrically opposed, and it is challenging to balance both worlds. Currently, Transport for London (TfL) is employing a system wherein an EMV contactless device is presented at the turnstile and an offline update and authentication occurs; if successful, the turnstile opens. However, conventional authorization and clearing via the open-loop payment card network happen during the course of the day. Currently, DCVC3 validation and offline data authentication are done either prior to or in conjunction with an actual auth or clearing via the open-loop payment card network. By default, currently, if DCVC3 validation or offline data authentication occur, this always leads to an auth and clearing transaction in the open-loop payment card network. In contrast, one or more embodiments carry DCVC3 validation or offline data authentication in a closed loop environment, without any transaction in the open-loop payment card network.

In the current TfL system, offline data authentication for the presented EMV contactless device occurs locally in conjunction with the payment device and the terminal and does not involve communication with the issuer In one or more embodiments, keys to a Ventra MasterCard BIN or the like are locally based or are located on a remote host that is not connected to the issuer.

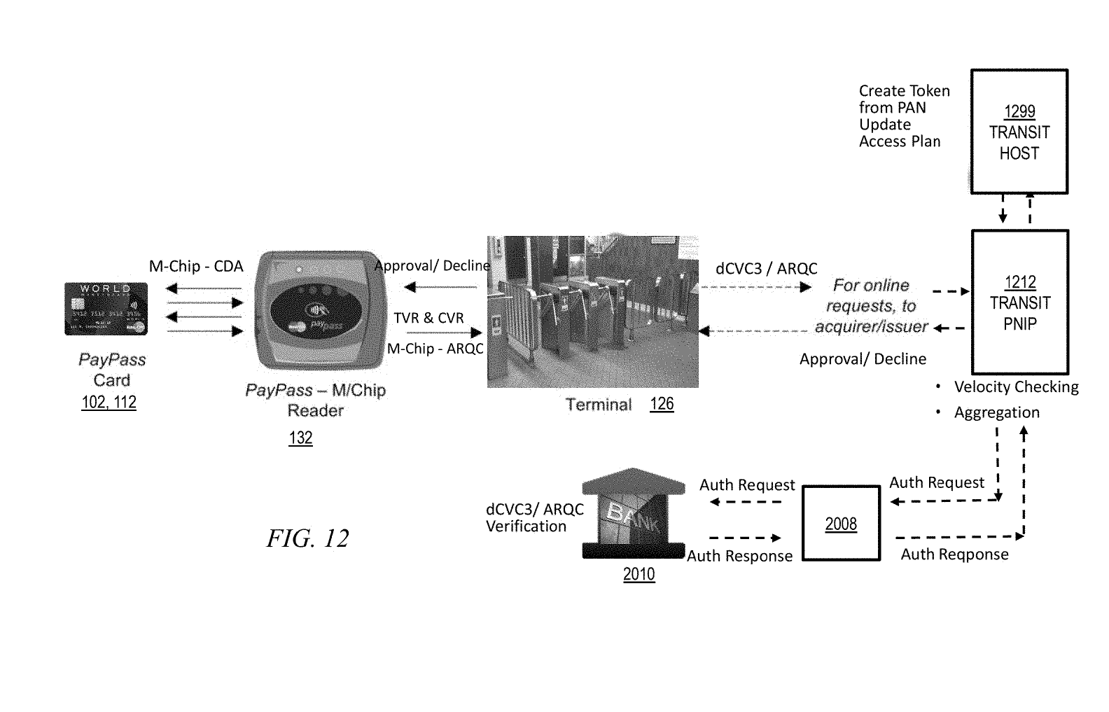

Reference should now be had to FIG. 12, which shows a pay-as-you go contactless transaction architecture, in accordance with an aspect of the invention. A variety of approaches may be employed in one or more embodiments. In some instances, an approach similar to EMV offline authentication can be employed; in others, an approach similar to EMV online can be employed, but with the transit PNIP 1212 standing in for the issuer. A transit rider presents his or her chip card (contacted or contactless) 102, 112 at reader 132 (one or more embodiments do not employ non-chip mag stripe cards). Authentication of the card is initiated, without the need to communicate with the issuer 2010; in the non-limiting example of FIG. 12, CDA is employed (other techniques such as SDA or DDA could be used in other embodiments). The Card Verification Results (CVR) (chip card internal registers that store information concerning the chip card functions performed during a payment transaction) reflect the PIN verification, the card risk management checks, and the status of the previous transaction. These are passed to the terminal 126, along with the ARQC if an on-line transaction is to be carried out (in one or more embodiments, the ARQC is passed to the transit PNIP 1212—where desired, business as usual validation via the issuer can be undertaken in some cases). In most cases, decisioning is local, and the terminal 126 passes the card-generated dynamic CVC3 or ARQC to the transit payment network interface processor (transit PNIP) 1212. The transit PNIP may be, for example, a MasterCard TMIP (Transit MasterCard Interface Processor) or the like. The transit PNIP carries out card authentication and verification.

Meanwhile, the transit host 1299 determines whether the transit rider should be allowed in, on a “financial” basis. In a registration process, or upon the first presentation of card 102, 112 in the transit system (or after registration/first use in some related system), transit host 1299 tokenizes the PAN of card 102, 112, allowing it to be used as an access token. For the avoidance of doubt, where a mobile or wearable device (generally, a payment device having a non-card form factor) is employed for payment, rather than an actual front-of-card PAN being present, a tokenized representation of the PAN is employed on the mobile device. This token is detokenized for further processing. Given the teachings herein, the skilled artisan will be able to adapt known tokenization techniques to implement one or more embodiments. Non-limiting examples of such techniques include those disclosed in the following United States Patent Publications, all of which are expressly incorporated herein by reference in their entireties for all purposes:
2015-0339663 METHODS OF PAYMENT TOKEN LIFECYCLE MANAGEMENT ON A MOBILE DEVICE
2015-0186990 METHODS AND SYSTEMS FOR MANAGING CONSUMER SAVINGS WITH CREDIT CARD TRANSACTIONS
2014-0310182 SYSTEMS AND METHODS FOR OUTPUTTING INFORMATION ON A DISPLAY OF A MOBILE DEVICE
2013-0297504 TRANSACTION DATA TOKENIZATION

Tokenization in the sense of employing a tokenized representation of a PAN instead of an actual PAN on a mobile device should be distinguished from treating any payment device (chip card or chip device with non-card form factor) as a linkage to a closed-loop transit account, even though there is also an open-loop credit, debit, or stored value account also associated with the payment device.

The financial arrangements (access plan) in the pay-as-you-go system may include allowing the rider in, for a first presentation, if the card is validated and authenticated by transit PNIP 1212 and other basic checks are passed, and then (without delaying turnstile operation), carrying out a full authorization request and authorization request response with issuer 2010 via payment card network 2008 (for a single fare amount or some additional amount (aggregation)). Reference is made to co-assigned U.S. Pat. Nos. 7,828,204 and 8,584,936 of Fiebiger et al., each entitled TECHNIQUES FOR AUTHORIZATION OF USAGE OF A PAYMENT DEVICE and each hereby expressly incorporated herein by reference in their entireties for all purposes. In some scenarios, the rider “taps on” and also “taps off” and the fare is determined at the end of the ride. In other instances, the fare is known a priori when the rider enters.

An approve or decline decision is returned from the transit PNIP 1212 to the terminal 126 based on the card 102, 112 passing local authentication and verification by transit PNIP 1212 and financial checks by transit host 1299, and then to the reader 132. Transit PNIP 1212 can also carry out velocity checking as part of the above-mentioned basic checks. When the full auth request and auth request response are carried out in communication with the issuer 2010 via payment card network 2008, the issuer 2010 will also carry out appropriate dynamic CVC3 or ARQC verification.

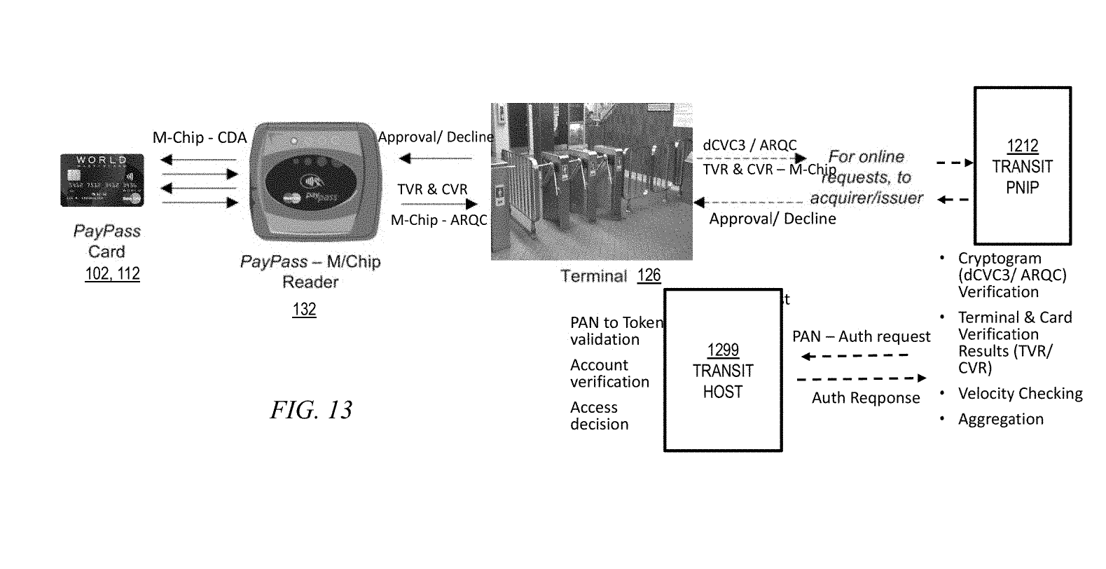

FIG. 13 shows a pre-funded contactless transaction architecture, in accordance with an aspect of the invention. In one or more embodiments employing this approach, value is stored on the device and a “pure” offline approach is utilized; however, if funds are not available on the device for offline, the device will request an online authorization and follow a pay-as-you-go approach. Authentication can be carried out offline in this aspect as a default, however, in some instances, if funds are not available on the device for offline, authentication can be carried out via the transit PNIP 1212 as described above with regard to FIG. 12. Again, a transit rider presents his or her chip card (contacted or contactless) 102, 112 at reader 132 (one or more embodiments do not employ non-chip mag stripe cards). Authentication of the card is initiated, without the need to communicate with the issuer 2010; in the non-limiting example of FIG. 13, CDA is employed (other techniques such as SDA or DDA could be used in other embodiments). The Card Verification Results (CVR) (chip card internal registers that store information concerning the chip card functions performed during a payment transaction) reflect the PIN verification, the card risk management checks, and the status of the previous transaction. In the case where the transit PNIP 1212 is employed, these are passed to the terminal 126, along with the ARQC if an on-line transaction is to be carried out. Decisioning is local, and the terminal 126 passes the card-generated dynamic CVC3 or ARQC (or TVR and CVR) to the transit payment network interface processor (transit PNIP) 1212. The transit PNIP may be, for example, a MasterCard TMIP (Transit MasterCard Interface Processor) or the like. The transit PNIP carries out card authentication and verification. In particular, the transit PNIP can undertake velocity checking, check the TVR and CVR, and verify the cryptogram (dynamic CVC3 or ARQC).

Aggregation can be carried out via clearing records; in essence, aback end process.

Meanwhile, the transit host 1299 determines whether the transit rider should be allowed in, on a “financial” basis (account verification and access decision). In a registration process, or upon the first presentation of card 102, 112 in the transit system (or after registration/first use in some related system), transit host 1299 tokenizes the PAN of card 102, 112, allowing it to be used as an access token. The financial arrangements in the pre-funded system generally include storing value in the “shadow” account. The rider is allowed in if the card is validated and authenticated by transit PNIP 1212 and other basic checks are passed, and if there are adequate funds in the “shadow” account.

An approve or decline decision is returned from the transit PNIP 1212 to the terminal 126 based on the card 102, 112 passing local authentication and verification by transit PNIP 1212 and financial checks by transit host 1299, and then to the reader 132. Note that communications from the reader to the transit PNIP 1212 may be, for example, in a protocol of the transit operator, while communications from the transit PNIP 1212 out to the issuer or transit host may be, for example, in a format specific to the transit PNIP 1212; for example, ISO 8583, a modified version of ISO 8583, or a transit PNIP-specific application programming interface (API).

One or more embodiments thus advantageously provide a transit risk management (TMIP) processing solution that enables open loop contactless device acceptance in transit while providing POS/validator response time that maximizes rider throughput. One or more embodiments manage the risk to enable the acceptance of open loop cards at the fare gate POS reader and bus validator within acceptable transaction times (<˜500 ms). In one or more embodiments, all of the fare options and features currently available to transit agencies and consumers can be implemented. One or more instances are well-suited for complex fare structures including transfers, distance-based and fare capping. In one or more embodiments, the transit PNIP 1212 performs velocity and pattern checking to detect suspect access requests, checks riders access against active and non-active card lists, checks (e.g., MasterCard and Visa) credentials against their respective hot lists. In some cases, incremental details on reasons for decline messages from the issuer are provided. Fares can be aggregated up to a maximum spend and/or time limit before a new authorization is required. Appropriate rules can be implemented; for example, in one non-limiting exemplary embodiment, a MasterCard post-authorized aggregated rule for contactless transit transactions allows a $15 hold on a $1 authorization in transit environments.

### Recapitulation

Given the discussion thus far, it will be appreciated that, in general terms, an exemplary method, according to an aspect of the invention includes obtaining, at a terminal-reader assembly 126, 132 in a closed-loop transit environment, presentation of an open-loop smart chip-based payment device such as 102, 112 or a non-card form factor device. A further step includes carrying out verification of cryptographic credentials associated with the open-loop smart chip-based payment device, at a transit payment network interface processor 1212 within the closed-loop transit environment. An even further check includes performing a financial check of an account associated with the open-loop smart chip-based payment device. A still further step includes, responsive to determining that the verification and financial check are successful, granting access to the transit environment (e.g., activate turnstile) to a holder of the open-loop smart chip-based payment device.

In one or more embodiments, the verification of the cryptographic credentials associated with the open-loop smart chip-based payment device, at the transit payment network interface processor 1212 within the closed-loop transit environment, is carried out in accordance with an open-loop payment card processing standard.

The financial check is typically carried out remotely from the payment network interface processor 1212, as discussed below. In some instances, the financial check is carried out on the open-loop smart chip-based payment device (e.g., by checking its online balance). In other cases, the financial check is carried out at a transit host 1299 within the closed-loop transit environment. In one or more embodiments, the transit payment network interface processor 1212 and transit host 1299 are separate computing devices.

In one or more embodiments, granting access, while responsive to determining that the verification and financial check are successful, is made without reliance on communications with the issuer 2010of the open-loop smart chip-based payment device.

The obtaining, carrying out verification, and performing steps can be repeated for another presentation of an open-loop smart chip-based payment device, which may be the same device or a different device. Of course, in a typical system, there will be many devices and many repetitions. Responsive to determining that at least one of the repeated verification and repeated financial check are not successful, access to the transit environment is declined to a holder of the open-loop smart chip-based payment device used in this other presentation.

As noted, in some cases, the financial check is carried out at a transit host within the closed-loop transit environment. The account associated with the open-loop smart chip-based payment device can this be a shadow transit account, and the performing of the financial check includes checking a balance of the shadow account, residing on the transit host, for adequate funds.

In some instances, the account associated with the open-loop smart chip-based payment device is a conventional credit card open to spend line for a primary account number of the open-loop smart chip-based payment device or a deposit account associated with a conventional debit card account for the primary account number of the open-loop smart chip-based payment device. In such cases, performing of the financial check can include granting admission if basic checks are passed at the transit host, without a communication to the issuer.

### System and Article of Manufacture Details

Embodiments of the invention can employ hardware and/or hardware and software aspects. Software includes but is not limited to firmware, resident software, microcode, etc. Software might be employed, for example, in connection with one or more of a terminal 122, 124, 125, 126; a reader 132; transit PNIP 1212; transit host 1299; a host, server, and/or processing center 140, 142, 144 (optionally with data warehouse 154) of a merchant, issuer, acquirer, processor, bank, agent, third party, or operator of a payment network 2008; and the like. Firmware might be employed, for example, in connection with payment devices such as cards 102, 112, as well as reader 132.

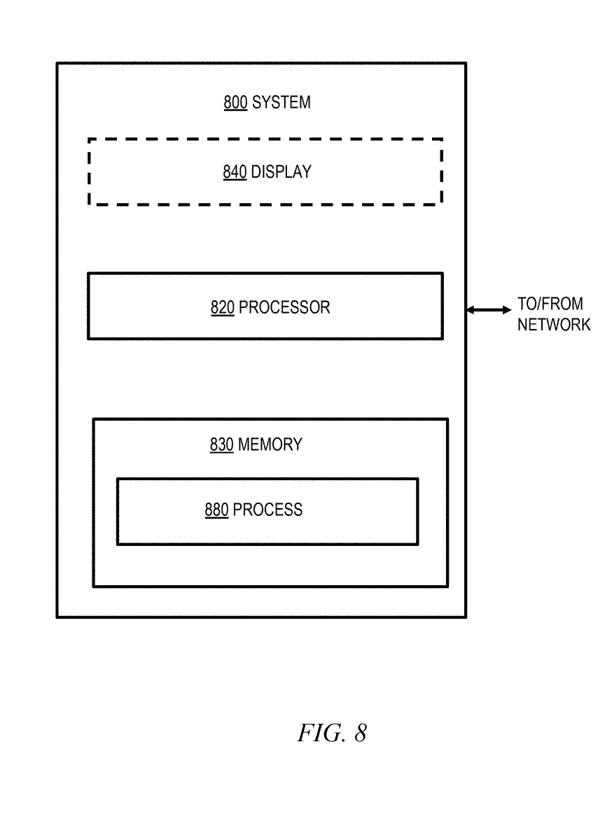

FIG. 8 is a block diagram of a system 800 that can implement part or all of one or more aspects or processes of the invention. As shown in FIG. 8, memory 830 configures the processor 820 (which could correspond, e.g., to processor portions 106, 116, 130; a processor of a terminal or a reader 132; processors of remote hosts in centers 140, 142, 144; processors of hosts and/or servers implementing systems in FIGS. 12 and 13 and their components; processors of hosts and/or servers of other parties described herein; and the like); to implement one or more aspects of the methods, steps, and functions disclosed herein (collectively, shown as process 880 in FIG. 8). System 800 is also representative of the computational functionality of a “smart” cellular telephone (which would also include wireless communication functionality in a well-known manner) or of a wearable device. Different method steps can be performed by different processors. The memory 830 could be distributed or local and the processor 820 could be distributed or singular. The memory 830 could be implemented as an electrical, magnetic or optical memory, or any combination of these or other types of storage devices (including memory portions as described above with respect to cards 102, 112). It should be noted that if distributed processors are employed, each distributed processor that makes up processor 820 generally contains its own addressable memory space. It should also be noted that some or all of computer system 800 can be incorporated into an application-specific integrated circuit (ASIC) or general-use integrated circuit. For example, one or more method steps could be implemented in hardware in an ASIC or field-programmable gate array (FPGA) rather than using firmware. Display 840 is representative of a variety of possible input/output devices (e.g., displays, printers, keyboards, mice, touch screens, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 2004, 2006, 2008, 2010, 102, 112, 132, 126, 1212, 1299; on a computer implementing aspects of systems in FIGS. 11 and 12 and their components; on processors of hosts and/or servers of other parties described herein; and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, 122, 124, 125, 126, 140, 142, 144, 2004, 2006, 2008, 2010, 102, 112, 132, 126, 1212, 1299; on a computer implementing aspects of systems in FIGS. 11 and 12 and their components; on processors of hosts and/or servers of other parties described herein; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 800 as shown in FIG. 8) running a server program. It will be understood that such a physical server may or may not include a display, keyboard, or other input/output components. A “host” includes a physical data processing system (for example, system 800 as shown in FIG. 8) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures or described herein. Referring again to FIGS. 12 and 13, in one or more embodiments, the modules include one or more database modules (e.g. residing on transit host 1299), a fare calculation module residing on transit host 1299 to determine fares in a well-known manner, software or firmware modules residing on the card, reader, and terminal as described herein; a module or modules with code to implement one or more APIs (e.g., for transit PNIP 1212); a module to carry out the cryptographic verification on transit PNIP 1212; modules to carry out the other functions of transit PNIP 1212, and the like.

The database module can include, for example, a (relational, graphical, or other) database management system (DBMS) which provides access to the database via queries and the like. The method steps can, in any event, be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

A user interface module to implement a user interface can include hypertext markup language (HTML) code served out by a server or the like, to a browser of a computing device of a user. The HTML is parsed by the browser on the user's computing device to create a graphical user interface (GUI).

Thus, aspects of the invention can be implemented, for example, by one or more appropriately programmed general purpose computers, such as, for example, servers, mobile devices, or personal computers, located at one or more of the entities in the figures, as well as within the payment network 2008. Such computers can be interconnected, for example, by one or more of payment network 2008, another VPN, the Internet, a local area and/or wide area network (LAN and/or WAN), via an EDI layer, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as relational database applications (e.g., IBM DB2® software available from International Business Machines Corporation, Armonk, N.Y., U.S.; SAS® software available from SAS Institute, Inc., Cary, N.C., US), spreadsheets (e.g., MICROSOFT EXCEL® software available from Microsoft Corporation, Redmond, Wash., U.S.), and the like. The computers can be programmed to implement the logic and/or data flow depicted in the figures. In some instances, messaging and the like may be in accordance with the International Organization for Standardization (ISO) Specification 5583 Financial transaction card originated messages—Interchange message specifications and/or the ISO 20022 or UNIFI Standard for Financial Services Messaging, also incorporated herein by reference in its entirety for all purposes.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
obtaining, at a terminal-reader assembly in a closed-loop transit environment, presentation of an open-loop smart chip-based payment device;
carrying out verification of cryptographic credentials associated with said open-loop smart chip-based payment device, at a transit payment network interface processor within said closed-loop transit environment;
performing a financial check of an account associated with said open-loop smart chip-based payment device; and
responsive to determining that said verification and financial check are successful, granting access to said transit environment to a holder of said open-loop smart chip-based payment device.

2. The method of claim 1, wherein said verification of said cryptographic credentials associated with said open-loop smart chip-based payment device, at said transit payment network interface processor within said closed-loop transit environment, is carried out in accordance with an open-loop payment card processing standard.

3. The method of claim 1, wherein said financial check is carried out on said open-loop smart chip-based payment device.

4. The method of claim 1, wherein said financial check is carried out at a transit host within said closed-loop transit environment.

5. The method of claim 4, wherein said granting of said access, while responsive to said determining that said verification and financial check are successful, is made without reliance on communications with an issuer of said open-loop smart chip-based payment device.

6. The method of claim 1, further comprising repeating said obtaining, carrying out verification, and performing steps for another presentation of an open-loop smart chip-based payment device; and
responsive to determining that at least one of said repeated verification and repeated financial check are not successful, declining access to said transit environment to a holder of said open-loop smart chip-based payment device used in said another presentation.

7. The method of claim 1, wherein said financial check is carried out at a transit host within said closed-loop transit environment, wherein said account associated with said open-loop smart chip-based payment device is a shadow transit account, and wherein said performing of said financial check comprises checking a balance of said shadow account, residing on a transit host, for adequate funds.

8. The method of claim 1, wherein:
said account associated with said open-loop smart chip-based payment device is one of:
a conventional credit card open to spend line for a primary account number of said open-loop smart chip-based payment device; and
a deposit account associated with a conventional debit card account for said primary account number of said open-loop smart chip-based payment device; and
said performing of said financial check comprises admission if basic checks are passed at a transit host.

9. A closed-loop transit system comprising:
a terminal-reader assembly; and
a transit payment network interface processor coupled to said terminal-reader assembly;
wherein said terminal-reader assembly is operative to obtain presentation of an open-loop smart chip-based payment device; and
wherein said transit payment network interface processor is operative to:
carry out verification of cryptographic credentials associated with said open-loop smart chip-based payment device;
obtain results of a financial check of an account associated with said open-loop smart chip-based payment device; and
responsive to determining that said verification and financial check are successful, grant access to said closed-loop transit system to a holder of said open-loop smart chip-based payment device.

10. The closed-loop transit system of claim 9, wherein said transit payment network interface processor carried out said verification of said cryptographic credentials associated with said open-loop smart chip-based payment device in accordance with an open-loop payment card processing standard.

11. The closed-loop transit system of claim 9, wherein said financial check is carried out on said open-loop smart chip-based payment device.

12. The closed-loop transit system of claim 9, further comprising a transit host coupled to said transit payment network interface processor, wherein said financial check is carried out at said transit host.

13. The closed-loop transit system of claim 12, wherein said granting of said access, while responsive to said determining that said verification and financial check are successful, is made without reliance on communications with an issuer of said open-loop smart chip-based payment device.

14. The closed-loop transit system of claim 9, further comprising a transit host coupled to said transit payment network interface processor, wherein said financial check is carried out at said transit host, wherein said account associated with said open-loop smart chip-based payment device is a shadow transit account, and wherein said performing of said financial check comprises checking a balance of said shadow account, residing on said transit host, for adequate funds.

15. The closed-loop transit system of claim 9, further comprising a transit host coupled to said transit payment network interface processor, wherein:
said account associated with said open-loop smart chip-based payment device is one of:
a conventional credit card open to spend line for a primary account number of said open-loop smart chip-based payment device; and
a deposit account associated with a conventional debit card account for said primary account number of said open-loop smart chip-based payment device; and
said performing of said financial check comprises admission if basic checks are passed at said transit host.

16. At least one non-transitory computer readable medium comprising computer executable instructions which when executed by a terminal-reader assembly in a closed-loop transit environment and a transit payment network interface processor within said closed-loop transit environment cause the terminal-reader assembly and the transit payment network interface processor to perform the method of:
obtaining, at said terminal-reader assembly, presentation of an open-loop smart chip-based payment device;
carrying out verification of cryptographic credentials associated with said open-loop smart chip-based payment device, at said transit payment network interface processor;
obtaining results of a financial check of an account associated with said open-loop smart chip-based payment device; and
responsive to determining that said verification and financial check are successful, granting access to said transit environment to a holder of said open-loop smart chip-based payment device.

17. The non-transitory computer readable medium of claim 16, wherein said verification of said cryptographic credentials associated with said open-loop smart chip-based payment device, at said transit payment network interface processor within said closed-loop transit environment, is carried out in accordance with an open-loop payment card processing standard.

18. The non-transitory computer readable medium of claim 16, wherein said financial check is carried out on said open-loop smart chip-based payment device.

19. The non-transitory computer readable medium of claim 16, wherein said financial check is carried out at a transit host within said closed-loop transit environment.

20. The non-transitory computer readable medium of claim 19, wherein said granting of said access, while responsive to said determining that said verification and financial check are successful, is made without reliance on communications with an issuer of said open-loop smart chip-based payment device.
